(19) United States
(12) Patent Application Publication
(10) Pub. No.: US 2012/0174719 A1
(43) Pub. Date: Jul. 12, 2012

(54) LONG ARM HOLE PUNCH SYSTEM

(76) Inventors: Lenore KAUFMAN, Manalapan, NJ (US); Perri RICHMAN, Basking Ridge, NJ (US)

(21) Appl. No.: 13/309,470

(22) Filed: Dec. 1, 2011

Related U.S. Application Data
(60) Provisional application No. 61/418,587, filed on Dec. 1, 2010.

(51) Int. Cl. B26F 1/02; B26D 7/18; B26F 1/14

(52) U.S. Cl. 83/23; 83/109; 83/684; 83/691; 83/55

(57) ABSTRACT

The invention pertains to a novel hole punch system including a punch assembly removably coupled to a frame member. In one embodiment, the frame member has an elongated slide track defining a slot along which the punch assembly may be movably positioned. The punch assembly may include a punch mechanism for punching a hole in a material and a chad dispenser mechanism for efficiently storing and discharging accumulated chads.

### CROSS-REFERENCE TO RELATED APPLICATIONS

This application is a non-provisional of and claims the benefit of priority to U.S. Provisional Patent Application No. 61/418,587 on filed Dec. 1, 2010, the entire disclosure of which is herein incorporated by reference in its entirety.

### BACKGROUND OF THE INVENTION

1. Field of the Invention

This invention is generally related to the field of hand held hole punch systems. In particular, the invention is directed to hand held, adjustable and modular hole punch system for punching holes in materials, such as paper.

2. Description of the Related Technology

Conventional hole punch apparatuses are not designed to enable adjustable, far reaching and precise hole punch placement. Instead, they incorporate fixed punch mechanisms or punch mechanisms with limited adjustability that require a user to shift, bend or fold a paper to be hole punched within these devices in order to achieve a desired hole placement. For example, hole punches such as U.S. Pat. No. 5,463,922 have multiple fixed cutting tools that enable the formation of a line of holes. Such devices, however, do not enable the movable adjustment of their hole punching mechanism and therefore do not enable precise hole punch placement. Additionally, conventional three hole punch devices, such as the Master 3-Hole Adjustable Punch™, have adjustable cutting tools that are awkwardly coupled along a side of the hole punch frame and difficult to maneuver. Furthermore these devices restrict adjustability providing only a limited number of preset adjustable positions for the cutting tools.

Furthermore, standard hole punch apparatuses do not have an efficient means for interchangeably mounting hole punch mechanisms having differently shaped cutting edges to produce holes and chads of different shapes and sizes. U.S. Pat. No. 6,918,332, for example, includes a plurality of cutting members and corresponding templates that may be selectively coupled to a lower end of a hole punching piston and lower portion of the hole punch apparatus. The attachment location of the cutting members, however, is difficult to access and can impedes attachment. Furthermore, the requirement of a correspondingly shaped template is inefficient and, when misplaced or lost, renders the corresponding cutting member inoperable.

Conventional hole punch apparatus further do not include an efficient and space saving chad discharge mechanism adapted to cleanly and efficiently discharge chads formed by hole punching.

In view of the deficiencies, there is a need to develop a long arm hole punch system that enables adjustable, long reaching and precision hole punch placement. In particular, there is a need to develop an efficient hole punch apparatus adapted to facilitate storage and discharge of chads as well as a device that is capable of efficiently interchanging punch assemblies for forming holes and chads of different configurations.

### SUMMARY OF THE INVENTION

Accordingly, the invention is directed to an improved hole punch assembly and method for using the hole punch assembly. In a first aspect, the invention is directed to a hole punch system including a punch assembly for punching a hole in a material. The punch assembly includes a punching means for punching a hole in a material and a chad discharge means for storing and discharging chads, wherein the punching means and chad discharge means are interrelated but operatively independent of one another.

In a second aspect, the invention is directed to a hole punching system including an elongated frame member for receiving and punching a hole in a material and a punch assembly. The frame member includes a base member and a punch assembly receiving member connected to and spaced apart from the base member to form a first slot for receiving the material. The punch assembly receiving member includes a slide track forming an elongated second slot positioned through the punch assembly receiving member, wherein the second slot has a horizontal longitudinal axis and is positioned above and is connected to the first slot. The punch assembly of the system is slidably attached to the slide track and capable of passing through the second slot at various locations along a length of the second slot to enable adjustable hole punch placement in the material, wherein a user is able to view the material through the second slot to facilitate hole punch placement.

In a third aspect, the invention is directed to a method for hole punching. The method involves the steps of: positioning a material within a first slot of a hole punch apparatus; looking through an elongated second slot positioned through a punch assembly receiving member of the hole punch apparatus to view the material positioned within the first slot and a desired hole punch location of the material; slidably positioning a first punch assembly along a track of the punch assembly receiving member forming the second slot so as to align the first punch assembly with the desired hole punch location; and actuating the first punch assembly to punch a hole in the material.

### BRIEF DESCRIPTION OF THE DRAWINGS

FIG. 1(a) is a perspective view of a first embodiment of the hole punch systems including two punch assemblies capable of being removably and interchangeably coupled to a support frame.

FIG. 1(b) is an exploded view of a punch assembly of FIG. 1(a).

FIG. 1(c) are cross-sectional diagrams of the punch assembly of FIG. 1(b) illustrating operation of the hole mechanism seated within the mounting device as well as separate from the mounting device.

FIG. 1(d) shows various configurations of the tapered ends of a hole punching ram forming a cutting edge.

FIG. 1(e) is a perspective view of the hole punch system of FIG. 1(a), wherein a punch assembly is slidably coupled to the support frame.

FIG. 1(f) is a top view of the hole punch system of FIG. 1(e).

FIG. 1(g) is an exploded view of the hole punch system of FIG. 1(e).

FIG. 1(h) is an exploded view of the hole punch system of FIG. 1(e) showing an alternative base member.

FIG. 1(i) is a perspective top view of the assembled base member of FIG. 1(h).

FIG. 1(j) is a perspective bottom view of the assembled base member of FIG. 1(h).

FIG. 2(a) is an elevated perspective view of a second embodiment of the hole punch system.

FIG. 2(b) is a perspective of a first side of the hole punch system of FIG. 2(a).

FIG. 2(c) is a perspective of a second side of the hole punch system of FIG. 2(a) adjoining the first side depicted in FIG. 2(b).

FIG. 2(d) is a top view of the hole punch system of FIG. 2(a).

FIG. 2(e) is a cross-sectional view of the hole punch system of FIG. 2(a) taken at line A-A of FIG. 2(d).

FIG. 2(f) is a cross-sectional view of the hole punch system of FIG. 2(a) taken at line B-B of FIG. 2(d) showing the punch assembly.

FIG. 2(g) is a perspective view of the hole punch system of FIG. 2(a) seated in a mounting device.

FIG. 2(h) is a perspective cross-sectional view of the hole punch assembly of FIG. 2(a) removably attached to the frame member.

FIG. 2(i) is a perspective cross-sectional view showing the cutting edge of the punch assembly of FIG. 2(a).

FIG. 2(j) are cross-sectional diagrams of the punch assembly of FIG. 2(a) illustrating operation of the hole mechanism seated within the mounting device as well as separate from the mounting device.

FIG. 2(k) are cross-sectional diagrams of the punch assembly of FIG. 2(a) illustrating operation of the chad discharge mechanism seated within the mounting device as well as separate from the mounting device.

FIG. 2(l) is an exploded view of the hole punch system of FIG. 2(a).

FIG. 3(a) is a top perspective view of a third embodiment of the hole punch system.

FIG. 3(b) is a view of a first side the hole punch system of FIG. 3(a).

FIG. 3(c) is a perspective view of the hole punch system of FIG. 3(a) including a lever operatively associated with the punch assembly.

FIG. 3(d) is a perspective view of the support frame adapted to be removably coupled to the mounting device and a punch assembly.

FIG. 3(e) is a bottom perspective view of a punch assembly removably coupled to a mounting device.

FIG. 3(f) is a perspective view of a frame member removably coupled to the mounting device FIG. 3(e).

### DETAILED DESCRIPTION OF THE PREFERRED EMBODIMENT(S)

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

As used herein and in the appended claims, the singular forms “a”, “an”, and “the” include plural references unless the context clearly dictates otherwise. Additionally, the terms “a” (or “an”), “one or more” and “at least one” can be used interchangeably herein. The terms “comprising”, “including”, and “having” can also be used interchangeably.

Unless otherwise defined, all technical and scientific terms used herein have the same meaning as commonly understood by one of ordinary skill in the art to which this invention belongs. For purposes of the present application, the term, “chad” refers to a cut-out produced from punching a hole in a material. As used herein, chad may refer to a cut-out formed in any material, including paper, cardboard, foam board, fabric, thin plastic sheets or thin metal sheets.

The present invention relates to novel hole punch system and method for using the system to punch a hole through a material. This technology may be predicated upon the importance of: providing a long arm hole punch assembly that enables adjustable, far reaching and precise hole punch placement; enabling visual confirm of a desired hole punch location; providing a discharge mechanism that stores and efficiently discharges chads; interchangeable punch assemblies which may be removably attached to various hole punch frames members; and providing a cutting surface with a removable resilient strip of material to facilitate hole punching.

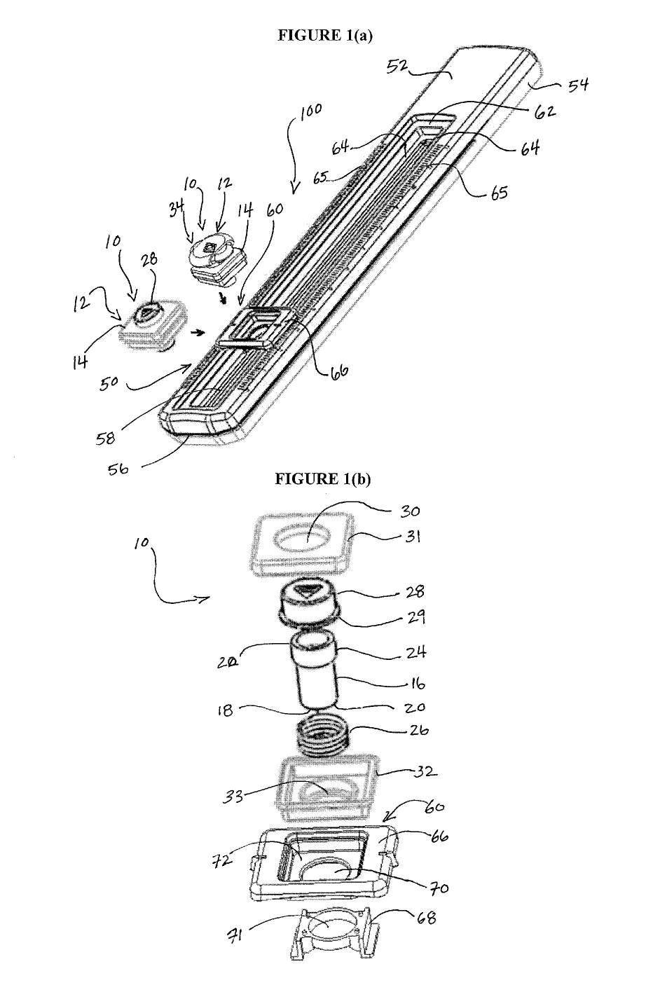

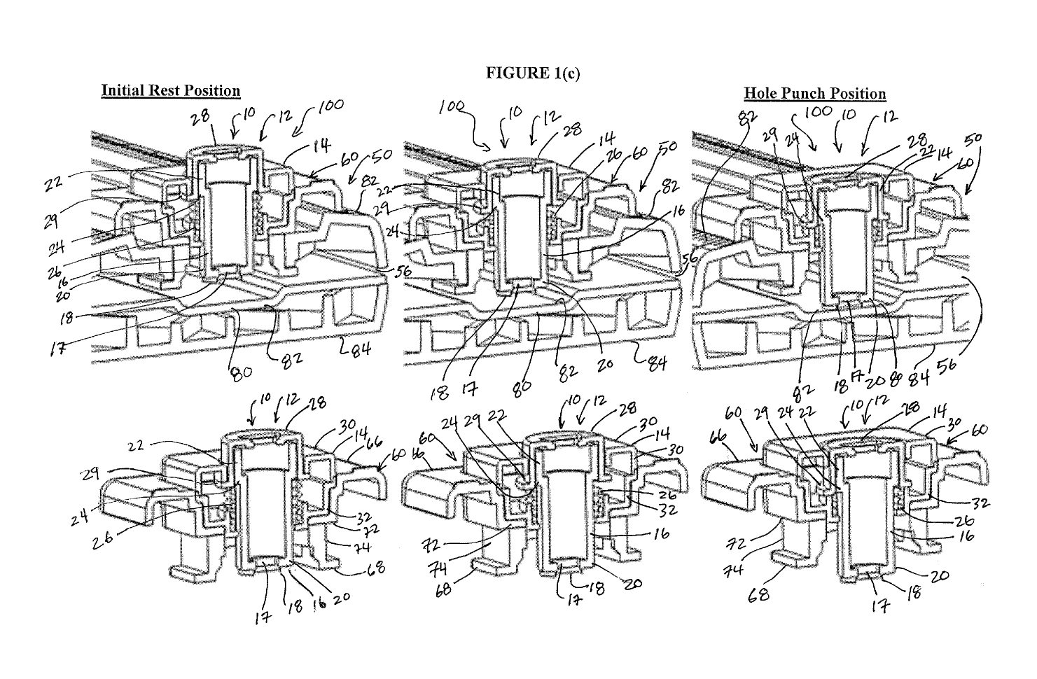

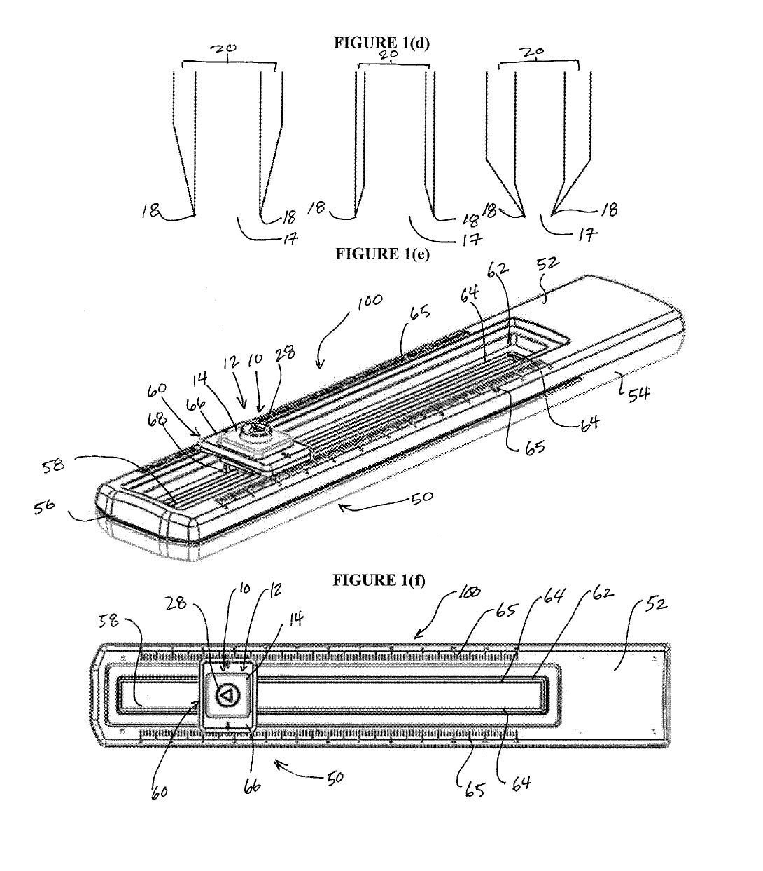

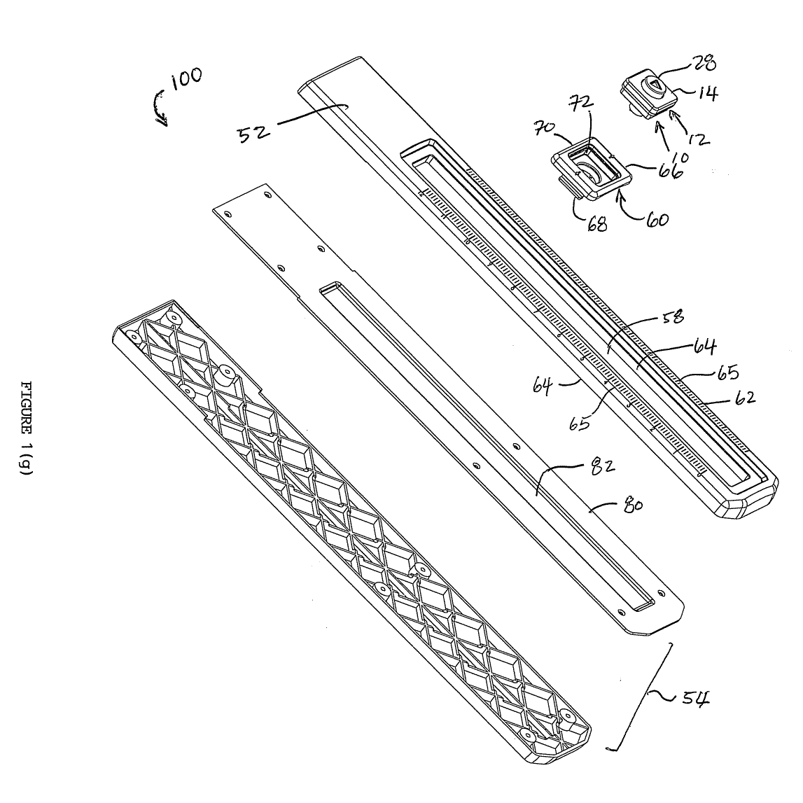

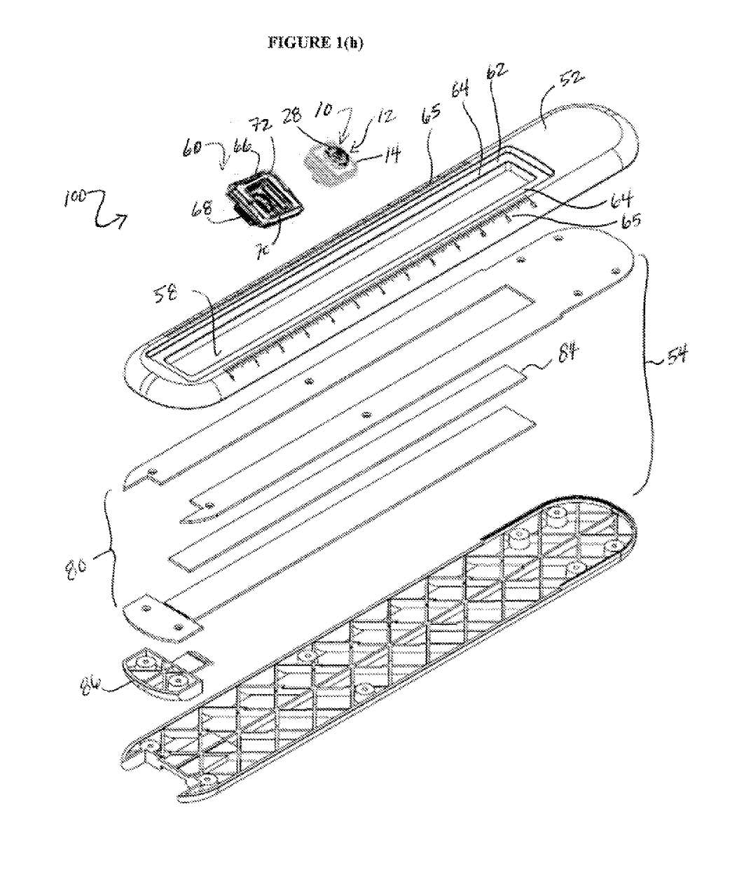

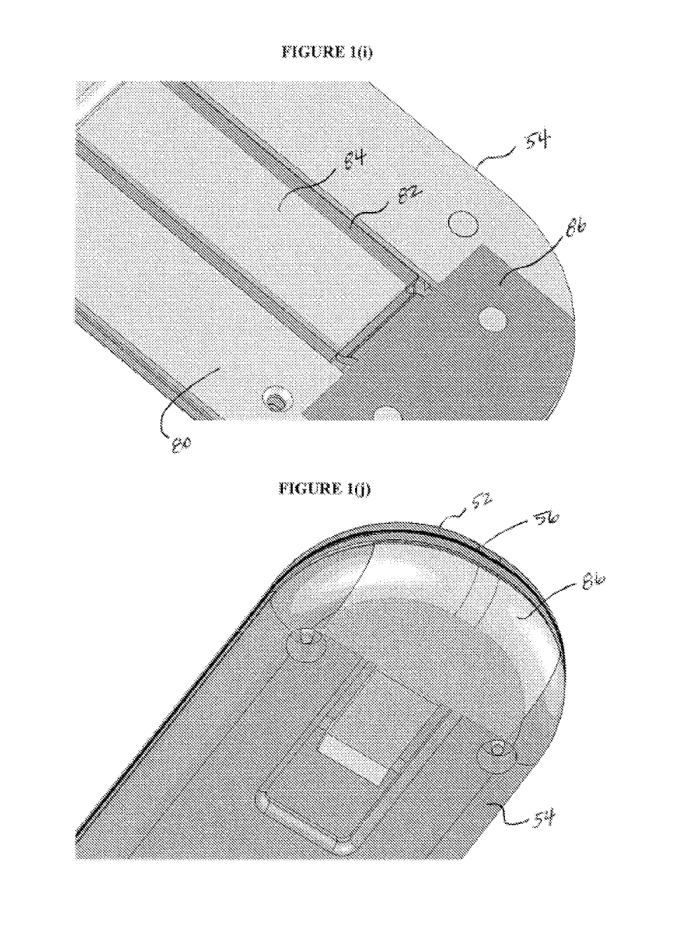

Referring now to the drawings, wherein like reference numerals designate corresponding structures throughout the various figures, FIGS. 1(a)-1(j) show a first embodiment of the hole punch system of the present invention. First hole punch system 100 includes one or more interchangeable punch assemblies 10 operatively associated with and removably attached to one or more interchangeable support frames 50 to form a modular hole punch apparatus. Each punch assembly 10 includes a punch mechanism 12 that enables hole punching. Each support frame 50 has a punch assembly receiving member 52 and a base member 54 that are connected to and spaced apart from one another to form an elongated first slot 56 for receiving and positioning a material to be punch. Support frame 50 further includes a mounting device 60 for removably coupling punch assembly 10 to punch assembly receiving member 52 such that punch assembly 10 is positioned within a second slot 58 extending through punch assembly receiving member 52. In an exemplary embodiment, second slot 58 is preferably configured as a horizontally elongated opening formed by a slide track 62 of punch assembly receiving member 52, wherein punch assembly 10 is slidably and adjustably positioned thereon to enable far reaching and precise hole punch placement. This horizontally elongated configuration of second slot 58 allows a user to directly view the material to be punched when positioned within first slot 56 and visually confirm the desired hole punch location by looking through second slot 58 and first slot 56. First hole punch system 100 is therefore preferably configured as an efficient, modular, handheld system capable of adjustably positioning punch assembly 10 to enable precise hole punch placement.

As shown in FIGS. 1(a)-1(c), punch assembly 10 includes a punch mechanism 12 having a ram 16 operatively associated with a first spring 26 and attached to a first actuator 28 that vertically depresses ram 16 down in order to initiate hole punching upon depressing first actuator 28. Ram 16 and first actuator 28 extend vertically through and are constrained by a casing 14 of punch mechanism 12. Punch mechanism 12 thereby forms a punching means for punching a hole in a material.

FIGS. 1(b)-1(c) show the various components of punch mechanism 12. As illustrated, ram 16 has a cutting edge 18 adapted for hole punching. Cutting edge 18 is formed on a lower first end 20 of ram 16, and is configured to produce a chad having a specific size and shape. Preferably, the edges of first end 20 tapers to cutting edge 18 forming a sharp blade adapted for hole punching. In one embodiment, tapered ram first end 20 may have a vertically straight, linear inner wall and an inclined outer wall that tapers towards the inner wall to form cutting edge 18, as shown in the far left image of FIG. 1(d). In another embodiment, tapered ram first end 20 may have a vertically straight, linear outer wall and an inclined inner wall that tapers towards the outer wall to form cutting edge 18, as shown in the middle image of FIG. 1(d). In yet another embodiment, both the inner and outer walls of tapered ram first end 20 may be inclined relative to one another forming a V shaped configuration, as shown in the far right image of FIG. 1(d). Preferably, tapered ram first end 20 pushes chads in a downward direction away from first end 20 such that the chads fall to and are collect on cutting surface 80 of support frame 50. Exemplary configurations of cutting edge 18 are shown in FIG. 1(d). Preferably, two or more punch assemblies 10 have different cutting edges 18 contoured for forming holes and corresponding chads of distinct designs, patterns and shapes. In an exemplary embodiment, punch assembly 10 may form holes and chads that are about 0.5 inches to about 2 inches in diameter having simple geometric shapes, such as a triangle, square, circle, diamond and star, or more complex designs and patterns.

A second end 22 of ram 16, opposite of first end 20, may have a ledge 24 protruding radially out from a perimeter of ram 16 forming a stepped configuration. Ledge 24 forms a shoulder with the exterior surface of ram 16 that engages an upper end of a first spring 26, which is disposed about and surrounds an exterior surface of ram 16. Attached to second end 22 is a first actuator 28, which induces ram 16 to initiate hole punching when depressed. First actuator 28 is preferably configured as a lever, button or other conventional mechanism for activating punch mechanism 12. A lower end of first actuator 28 may also engage an upper end of first spring 26 upon applying pressure to first actuator 28 to facilitate hole punching. An upper surface of first actuator 28 covers ram second end 22 and may illustrate the shape, pattern or design of the chad formed by punch assembly 10. In an exemplary embodiment, a hole having a shape corresponding to the chad produced by cutting edge 18 is defined in the upper surface 27 of first actuator 28 and extends through punch mechanism 12 enabling a user to view the material to be punched by looking through the hole formed in first actuator 28.

As shown in FIGS. 1(a)-1(c), punch mechanism 12 further includes a casing 14 that is operatively associated with and resiliently constrains the vertical movement of ram 16 and first actuator 28. Casing 14 includes an upper section 30 attached to lower section 32 forming an enclosure coupled to and encasing a portion of punch mechanism 12. Openings 31, 33 are respectively formed in the upper and lower sections 30, 32 of casing 14 defining a channel through which first actuator 28 and ram 16 are positioned. An upper portion of first actuator 28 protrudes up through opening 31 of upper section 30 and is restrained from separating from casing 14 by a radially protruding rim 29 of first actuator 28, the upper surface of which abuts an interior surface of casing upper section 30. First end 20 of ram 16 similarly extends down through opening 32 of casing lower section 32 and is restrained from separating from casing 14 by a lower end of first spring 26, which surrounds a portion of ram 16 and abuts an interior surface of casing lower section 32. Upon depressing first actuator 28, rim 29 or a lower portion of first actuator 28 and/or ledge 24 of ram 16 engages and presses against an upper end of first spring 26. Ram 16 may be vertically lowered until first spring 26 is fully compressed. Upon releasing the applied pressure to first actuator 28, first spring 26 reassumes its initial uncompressed state and applies an upward force to ram 16 and first actuator 28 to assume their initial rest position. By virtue of these mechanical constraints, first actuator 28 and ram 16 are therefore capable of reciprocating, vertically moving within the channel of casing 14 to induce hole punching.

FIGS. 1(a) and 1(e)-1(g) illustrate how punch assembly 10 is removably coupled to a support frame 50 and the various components of support frame 50. As shown, each support frame 50 has an elongated main body formed by a punch assembly receiving member 52 and a base member 54, which are attached to one another along one side thereof and spaced apart from one another to form an elongated first slot 56 for receiving and positioning a material to be punch. As shown in FIG. 1(e), punch assembly receiving member 52 and a base member 54 preferably has a C-shaped configuration that defines a centrally located first slot 56 positioned therebetween having a horizontal longitudinal axis. In an exemplary embodiment, punch assembly receiving member 52 and a base member 54 have an elongated configuration adapted for enabling far reaching hole punch placement, wherein first slot 56 has a length of about 6 inches or more, preferably, 12 inches or more, more preferably, about 18 inches or more, and most preferably about 24 inches or more. Preferably, first slot 56 has a length of about 6 inches to about 22 inches, more preferably, about 15 inches to about 22 inches. Additionally, the various components of frame member 50 and punch assembly 10 are preferably constructed from plastic materials, such as thermoplastic acrylonitrile butadiene styrene resins.

Punch assembly receiving member 52 has an elongated slide track 62 that forms a second slot 58 positioned through punch assembly receiving member 52, as illustrated in FIG. 1(e)-1(g). Slide track 62 is preferably recessed relative to an upper surface of punch assembly receiving member 52, forming a stepped configuration. Two parallel sides of slide track 62, defined by two parallel ledges 64 that protrude towards a center of second slot 58, provide a surface along which a mounting device 60 may be slidably and adjustably coupled. Ledges 64 and slide track 62 preferably span a substantial length of punch assembly receiving member 52 and may have a linear and/or curved configuration. As shown in FIGS. 1(e)-1(g), slide track 62 has a rectangular configuration, the longitudinal axis of which corresponds to that of punch assembly receiving member 52. Graduated markings on an exterior face of punch assembly receiving member 52 proximate to one or both sides ledges 64 form a scale 65 for facilitating the precise placement of a hole punch. Scales 65 may be formed on opposite sides of second slot 58 and may have the same or different units of measure. For example, one scale 65 may be measured in inches while a second scale 65 may be measured in centimeters. When two scales 65 are provided, the scales 65 may be inversely positioned relative to one another on opposite sides of slide track 62 to facilitate measurement in both directions.

Second slot 58 defined by slide track 62 is preferably configured as a horizontally elongated opening that allows a user to directly view the material to be punched when positioned within first slot 56 and to visually confirm the location of the intended hole punch. As shown in FIG. 1(e), second slot 58 is positioned above and is connected to so as to communicate with first slot 56 wherein ram 16 of punch assembly 10 vertically penetrates second slot 58 and first slot 56 at various locations along their lengths during hole punching. In an exemplary embodiment, first and second slots 56, 58 are substantially coextensive and have a corresponding horizontally oriented longitudinal axis. Preferably, second slot 58 and slide track 62 substantially spans the length of punch assembly receiving member 52 to enable far reaching and selective hole punch placement. In an exemplary embodiment, slide track 62 and second slot 58 have a length of about 6 inches or more, preferably, 12 inches or more, more preferably, about 18 inches or more, and most preferably about 24 inches or more. Preferably, first slot 56 has a length of about 6 inches to about 22 inches, more preferably, about 15 inches to about 22 inches.

As best shown in FIGS. 1(b), 1(c) and 1(g), a mounting device 60 of support frame 50 is adjustably coupled to slide track 62 for removably attaching punch assembly 10 to punch assembly receiving member 52. Mounting device 60 may be constructed from a two-part assembly including a punch assembly receptacle 66 that is removably attached to or integrally formed with a support frame coupler 68. Punch assembly receptacle 66 has a body including a recessed seat 72 forming a cavity for removably receiving punch assembly 10. A hole 70 is positioned through a lower end of recessed seat 72 to permit passage of a lower portion of punch assembly 10, namely ram 16, therethrough. Recessed seat 72 has a configuration corresponding to and adapted to securely receive a portion of punch assembly 10, specifically a lower section 32 of casing 14. Preferably, an upper section of casing 14 and/or first actuator 28 protrudes out and is elevated with respect to recessed seat 72 and/or the body of punch assembly receptacle 66 in order to provide a user with a gripping surface to facilitate insertion and removal of punch assembly 10 within mounting device 60. Preferably, punch assembly 10 is friction fitted, such as snap fitted, or screw fitted into recessed seat 72 and detachably secured therein. Alternatively, conventional mating fasteners, such as male and female fasteners, clamps, latches, hooks, clasps and snaps, may be positioned on an exterior surface of casing 14 and a surface of mounting device 60 to facilitate attachment, retention or detachment of punch assembly 10 relative to mounting device 60.

Preferably, punch assembly receptacle 66 is integrally connected to support frame coupler 68, which has at least two opposing outward extending arms for engaging a lower surface of slide track 62. The two arms of support frame coupler 68 are connected by a frame through which is a centrally defined hole 71 aligned with recessed seat hole 70 for receiving ram first end 20. As shown in FIGS. 1(b)-1(c), support frame coupler 68 and punch assembly receptacle 66 forming two opposing grooves 74 that are configured and adapted to mate with slide track ledges 64 such that mounting device 60 receives and is slidably positioned along slide track 62. As shown, grooves 74 have a C-shaped configuration corresponding to the thickness, contour and shape of slide track ledges 64, wherein ledge 64 is slidably received within grooves 74. In an alternative embodiment, grooves may be formed on an inner surface of slide track ledges 64 for slidably receiving a protruding portion of support frame coupler 68.

As a means of providing further stability, the body of punch assembly receptacle 66 extends over slide track ledge 64 and slidably engages an upper surface of punch assembly receiving member 52 adjacent to slide track 62, thereby further securing mounting device 60 to punch assembly receiving member 52 and providing further support to punch assembly 10.

Support frame 50 further includes a base member 54, as shown in FIG. 1(g), including a cutting surface 80 adapted to presses against cutting edge 18 of ram 16 to facilitate hole punching. Preferably, cutting surface 80 is configured as a rigid plate having a recessed section 82 defining a cavity. Cutting surface 80 may be constructed from any suitable materials, including metals, such as stainless steel, or hard plastics. Recessed section 82 preferably has a size, shape and position corresponding to second slot 58 such that it is positioned below and aligns with second slot 58 and is designed to catch and retain chads produced by hole punching. Preferably recessed section 82 is substantially equal to or longer than the dimension of second slot 58. During operation, a material is positioned within first slot 56 such that it is supported by an upper surface base member 54 that is elevated relative to recessed section 82. A hole is punched upon vertically lowering ram 16 such that cutting edge 18 passes through first slot 56, second slot 58 and into the cavity formed by recessed section 82. Chads formed by this hole punching process fall into recessed section 82 and may be periodically removed by turning the hole punch apparatus on its side and shaking loose the accumulated chads.

An alternative embodiment of base member 54 is shown in FIGS. 1(h)-1(j), wherein a resilient mat 84 is removably attached to an upper surface of and positioned within recessed section 82. Mat 84 is a resilient back pressure means that supports and facilitates contact between the material to be punched and cutting edge 18 when ram 16 is depressed. Preferably, mat 84 has a shape and configuration corresponding to and adapted to be positioned within recessed section 82. In one embodiment, mat 84 is an elongated rectangular strip of rubber. Exemplary materials used to construct mat 84 may include silicone or other rubber materials.

As mat 84 may be subject to cuts and scratches from repeated interaction with cutting edge 18, when worn, mat 84 may be detached and removed from recessed section 82. Mat 84 is preferably friction fitted within recessed section 82 to facilitate removal therefrom or may be adhesively secured to recessed section 82 such that an adhesive positioned on a lower surface of mat 82 enables removable positioning of mat 82. Other conventional fastening means that enables removable attachment, such as male and female fasteners, clamps, snaps, latches and hooks, may also be used to detachably seat mat 84 within recessed section 82.

Preferably, as shown in FIG. 1(j), the lower surface of base member 54 includes a clip 86, which can be slidably detached from base member 54 to enable access to recessed section 82 in order to facilitate removal and replacement of mat 84. Clip 86 is located at a distal end of and is slidably coupled to base member 54, wherein clip 85 forms part of the exterior housing of base member 54.

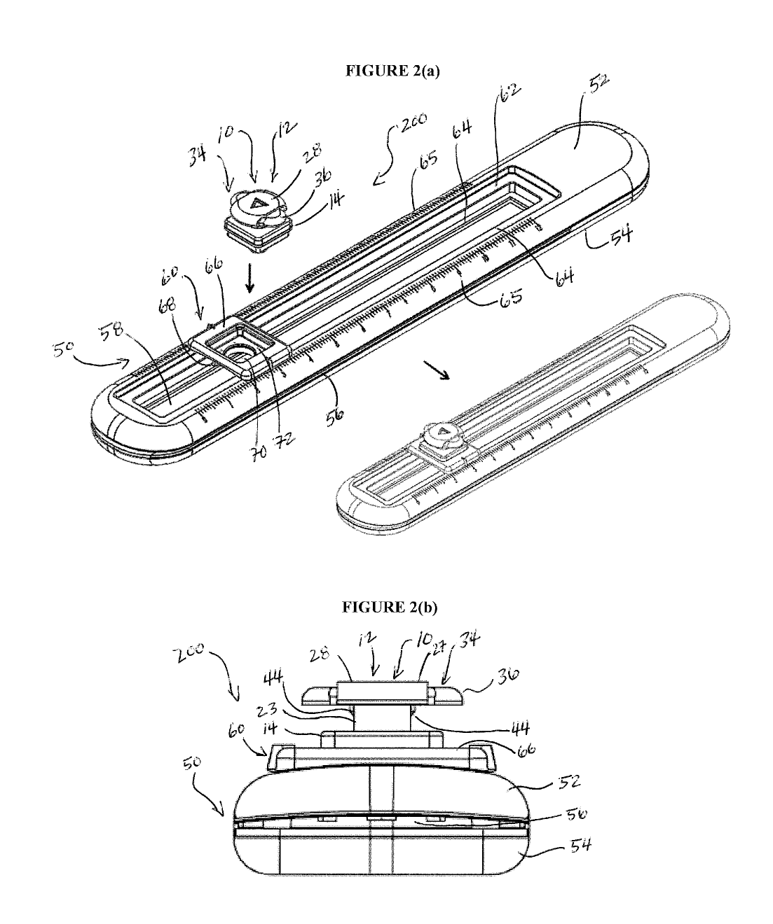

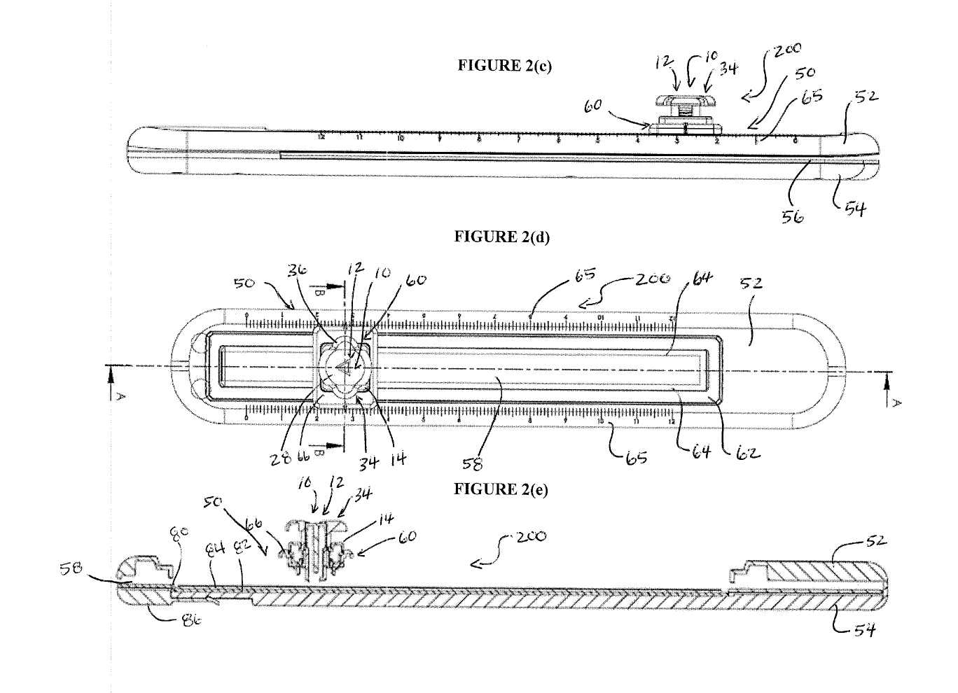

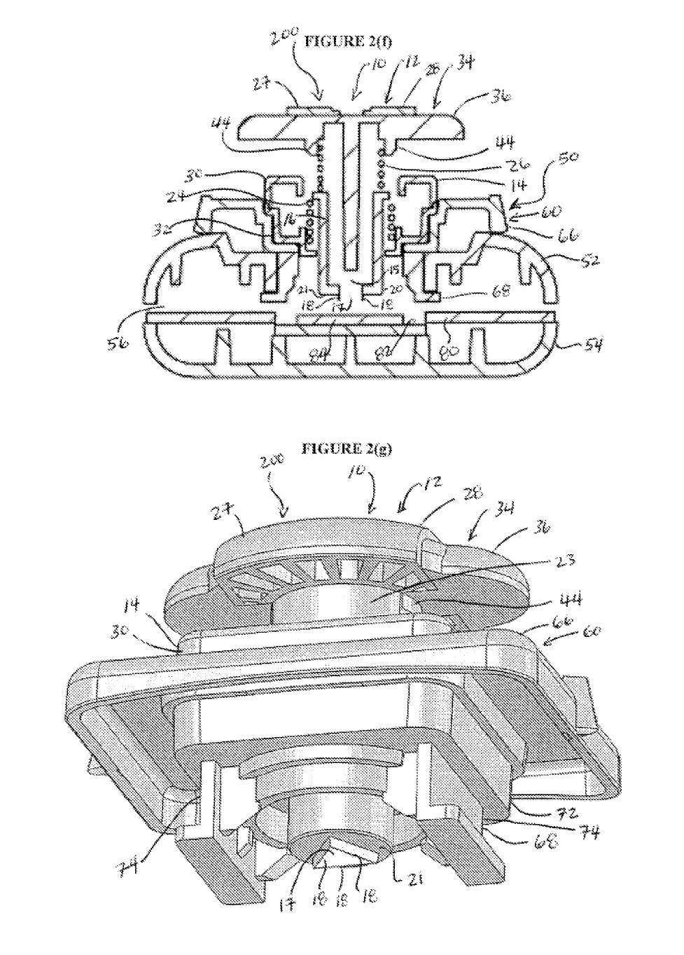

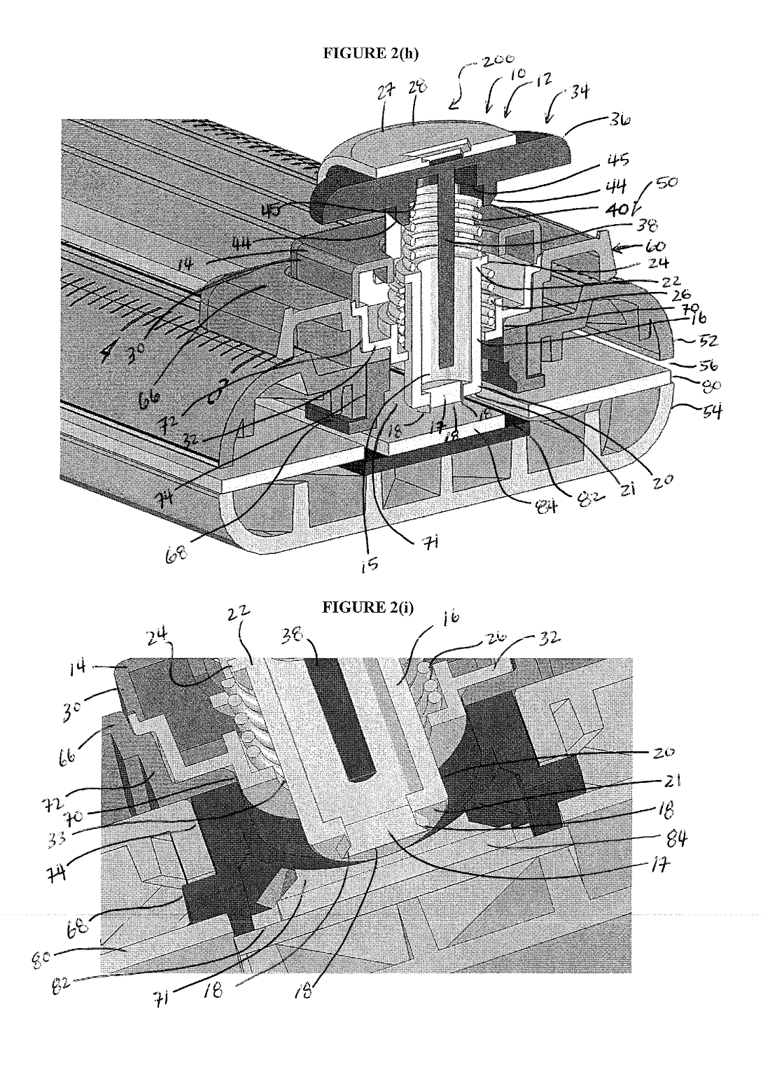

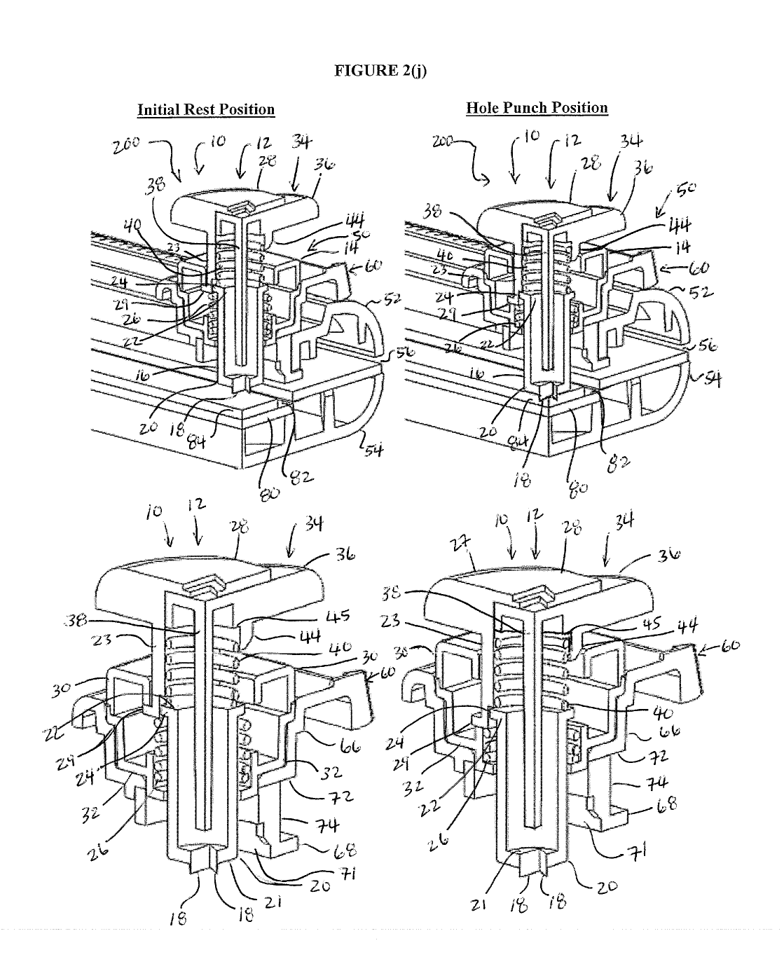

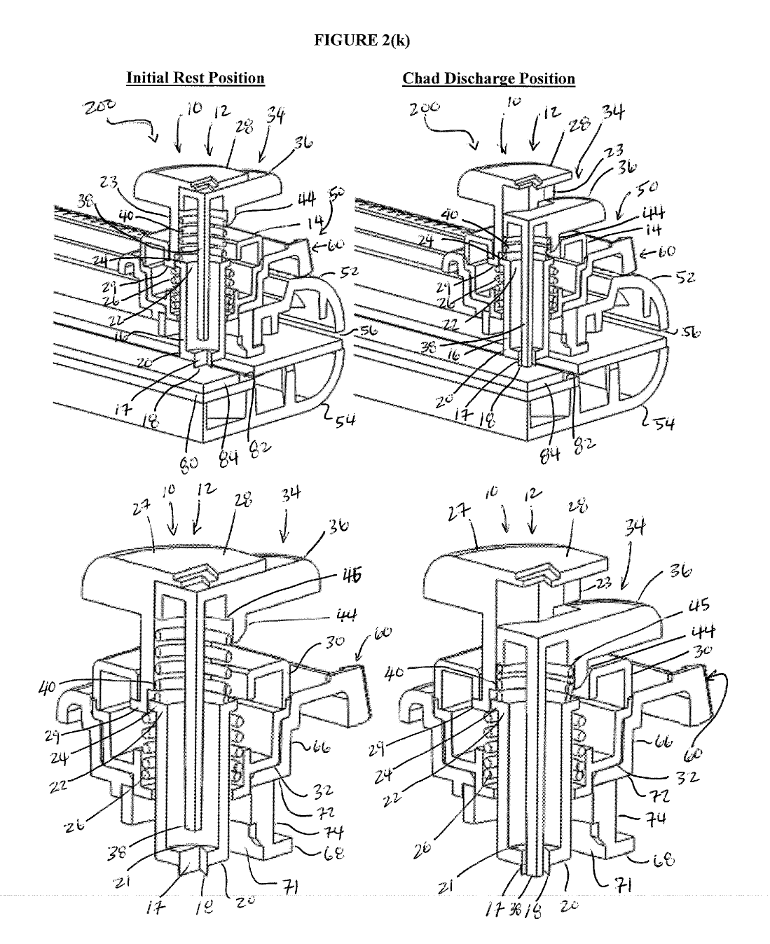

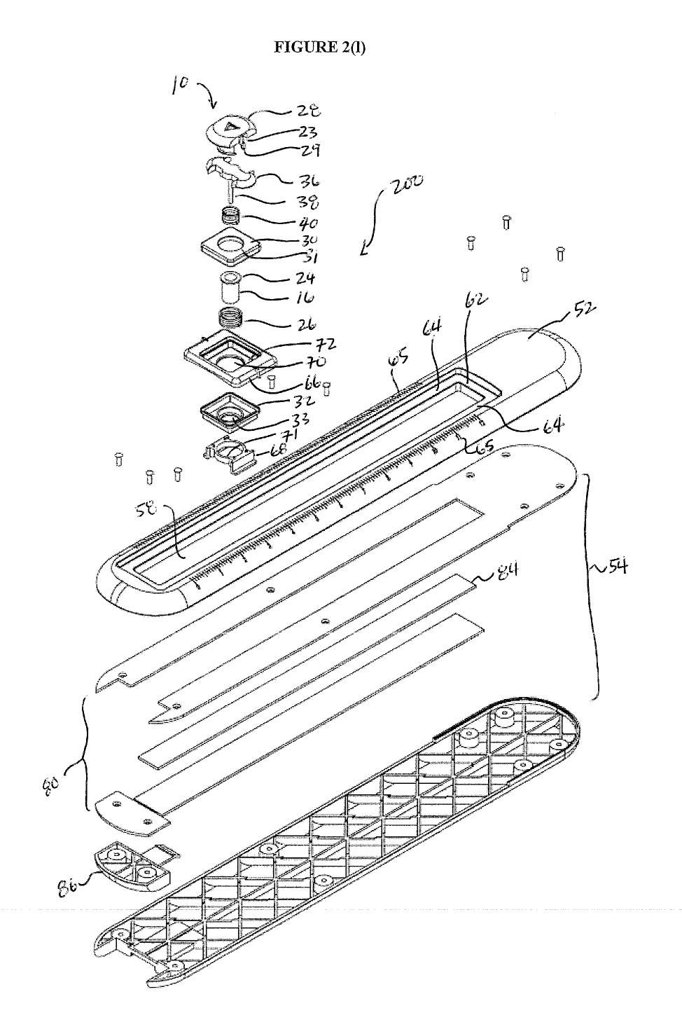

A second embodiment of the hole punch system is shown in FIGS. 2(a)-2(l). FIGS. 2(a)-2(e) shows that second hole punch system 200 is substantially the same as that of first hole punch system 100. With the exception of a modified punch assembly 10, second hole punch system 200 has the same essential and optional components, design and operational capability as that of first hole punch system 100. First hole punch system 100 includes one or more punch assemblies 10 removably coupled to one or more support frame 50, wherein each punch assembly 10 has a modified punch mechanism 12 and a chad discharge mechanism 34 that are interrelated but operatively independent of one another such that the actuation of the punching mechanism 12 does not induce chad discharge and actuation of the chad discharge mechanism 34 does not induce hole punching. In addition to enabling adjustable, long reaching and precise hole punch placement, second hole punch system 200 facilitates the efficient collection, storage and discharge of chads produced during hole punching.

As shown in FIG. 2(f)-2(l), punch assembly 10 of the present invention is substantially similar to the punch assembly 10 of first hole punch system 100. In this embodiment, punch assembly 10 includes a modified punch mechanism 12 associated with and independently operative with respect to a chad discharge mechanism 34. With the exception of a modified first actuator 28 and a modified lower first end 20 of ram 16, punch mechanism 12 of the hole punch assembly is the same as that described in first hole punch assembly 100.

As best shown in FIGS. 2(j)-2(k), first actuator 28 has a hollow shell body having an upper surface 27 forming an internal cavity having a configuration and dimension adapted for receiving second actuator 36. This internal cavity has a vertical thickness or length sufficient to permit second actuator 36 to be vertically depressed a distance that would enable a plunger 38 connected thereto to pass through hole 17 of ram first end 20. In an exemplary embodiment, the cavity has a vertical thickness or length of about 0.25 inches to about 1.5 inches, preferably, about 0.5 inches to about 1 inch.

First actuator 28 may alternatively have a hollow shell body defined by an upper surface 27 connected to and spaced apart from a lower surface that forms an internal cavity for receiving second actuator 36. The vertical distance between the upper and lower surfaces of first actuator 28 is sufficient to permit second actuator 36 to be vertically depressed so that plunger 38, connected to the lower surface of first actuator 28, passes through hole 17 of ram first end 20. The vertical distance between the interior, upper and lower surfaces of first actuator 28 defining the cavity of about 0.25 inches to about 1.5 inches, preferably, about 0.5 inches to about 1 inch.

One or more rigid support member 23 is integrally connected to a lower surface of first actuator 28 and extends vertically down to engage casing 14 and ram 16. In this embodiment, protruding rim 29 is formed on a lower end of support member 23 wherein a lower surface of rim 29 abuts an upper surface of ram ledge 24 in order to push ram 16 down to initiate hole punching. As discussed above, first spring 26 surrounds an upper portion of ram 16 and engages a lower surface of ram ledge 24, resisting and controlling the degree to which ram 16 is depressed. An upper surface of protruding rim 29 also abuts an interior surface of casing upper section 30 to restrain first actuator 28 from separating from casing 14.

In an exemplary embodiment, support member 23 may be configured as an elongated, curved configuration, such as a semi-cylindrical configuration.

As shown in FIGS. 2(f)-2(k), modified punch mechanism 12 further includes a ram first end 20 having an end face 21 through which a hole 17 is formed such that the edges of hole 17 form cutting edge 18. End face 21 surrounds hole 17 and encloses a portion of ram first end 20. Additionally, ram 16 has an internal chad receptacle 15 defined by walls 19 of ram 16, end face 21 and a lower end of chad dispenser mechanism 34 for receiving and retaining chads created by cutting edge 18 during hole punching. Chad receptacle 15 has a sufficient volume and dimensions to retain multiple chads without requiring frequently removal of accumulated chads. In an exemplary embodiment, chad receptacle 15 may simultaneously hold about 10 to about 100 chads, preferably about 25 to about 100 chads. In one embodiment, chad receptacle 15 has a length of about 0.5 inches to about 1.5 inches, preferably, about 0.5 to about 1 inch. As shown in FIGS. 2(h)-2(k), end surf 21 has a planar configuration adapted to receive and retain chads having a size that is substantially the same as hole 17, wherein cutting edge 18 has the same size and configuration as a uniform perimeter of hole 17. Alternatively, cutting edge 18 may be flared or angled such that it forms a hole 17 having an outer perimeter proximate to cutting edge 18 that is larger than an inner perimeter proximate to the internal space of chad receptacle 15.

As shown in FIGS. 2(h)-2(k), chad discharge mechanism 34 of second hole punch system 200 is located proximal to punch mechanism 12 such that a portion of chad discharge mechanism 34 is positioned within punch mechanism 12 to enable the discharge of chads from chad receptacle 15. Chad discharge mechanism 34 includes a second actuator 36, a plunger 38 integrally formed with and extending down from second actuator 36 and a second spring 40 operatively associated with second actuator 36, forming a chad discharge means effective for ejecting chads stored within punch mechanism 10. A portion of chad discharge mechanism 34 is located within chad receptacle 15 of ram 16 such that plunger 38 is integrally formed with a lower surface of second actuator 36 and extends down in a vertical direction through a central region of chad receptacle 15. Plunger 38 engages and ejects chads stored therein when plunger 38 is lowered relative to ram 16. As shown, a portion of second actuator 36 is positioned within a cavity of the hollow shell body of first actuator 28 such that it is located beneath and is surrounded by first actuator 28. Second actuator 36 includes an upper surface 42 that extends horizontally beyond the confines of first actuator 28, activation of which may be used to discharge chads without initiating hole punching. Second actuator 36 is preferably configured as a lever, button or other conventional mechanism for activating chad discharge mechanism 34. Second actuator 36 further includes one or more rigid support members 44 that engage second spring 40 and partially surrounds an upper portion of plunger 38. In the embodiment shown in FIGS. 2(g) and 2(j)-2(k), support members 44 attached to a lower surface of second actuator 36 form a substantially continuous structure with first actuator support member 23. Preferably, support members 44, 23 may form a continuous semi-cylindrical or cylindrical structure. In one embodiment, two second actuator support members 44 may be positioned on opposite sides of plunger 38 and ram 16, and two first actuator support members 23 may be positioned therebetween. Second spring 40 is vertically constrained between support members 44 and ram 16, such that an upper end of second spring 40 abuts and engages a lower surface of an internally projecting ridge 45 of support member 44 and/or a lower surface of second actuator 36 and such that a lower end of second spring 44 engages an upper end of ram 16, such as an upper end of ram ledge 24. In an initial rest position, second spring 40 is held in compression and situated to induce second actuator 36 to abut and press against the upper interior surface of first actuator 28. This fixed position of chad discharge mechanism 34 relative to punch mechanism 12 therefore enables activation of punch mechanism 12 without engaging chad discharge mechanism 34.

FIG. 2(k) illustrate the operation of chad discharge mechanism 34. Upon detaching punch assembly 10 from support frame 50, a user may engage second actuator 36 to initiate chad discharge. When a user depresses a portion of second actuator 36 that protrudes out from first actuator 28, second actuator 36 and plunger 38 are vertically lowered relative to first actuator 28 until plunger 38 extends through a lower first end 20 of ram 16, specifically through hole 17 defined by cutting edge 18. Support member 44 of second actuator 36 is preferably configured as a cylindrical body having a vertical, longitudinal axis corresponding to the longitudinal axis of ram 16 and plunger 38. A ridge 45 of support member 44 or lower end of second actuator 36 engages an upper end of second spring 40; the lower end of second spring 40 abuts and engages an upper surface of ram ledge 24 or upper end of ram 16. Second spring 40 positioned between support member 44 and ram 16 resists depression of second actuator 36 and operates to return second actuator 36 and plunger 38 to its original position relative to ram 16 upon removing the applied pressure to second actuator 36.

Second hole punch system 200 further includes a support frame 50, which is removably coupled to punch assembly 10 in the same manner as that described in first hole punch system 100. Support frame 50 of second hole punch system 200 may be the same as any of the aforementioned embodiments of the support frame 50 of first hole punch system 100. Preferably, support member 50 has a base member 54 including a resilient mat 84, as shown in FIGS. 1(h)-1(j), that is removably attached to an upper surface of base member recessed section 82 in order to facilitate hole punching. In this embodiment, when resilient mat 84 is pressed against cutting edge 18, chads formed during hole punching are forced up through hole 17 and into chad receptacle 15 of ram 16 by resilient mat 84. Preferably, mat 84 has a thickness or curvature adapted to facilitate the movement of chads up through hole 17.

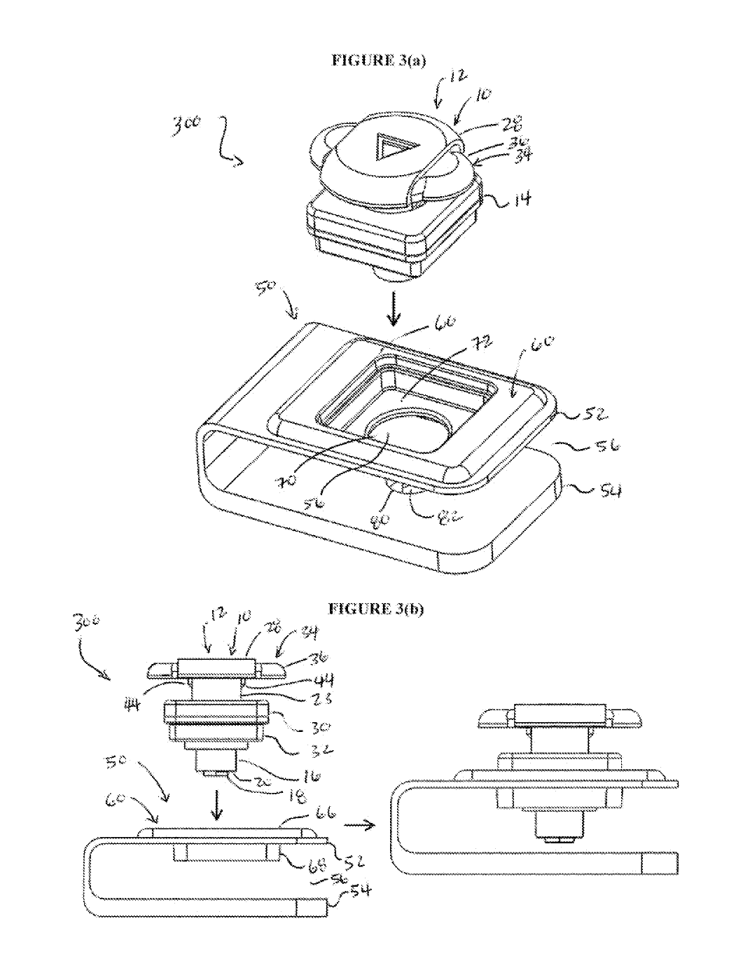

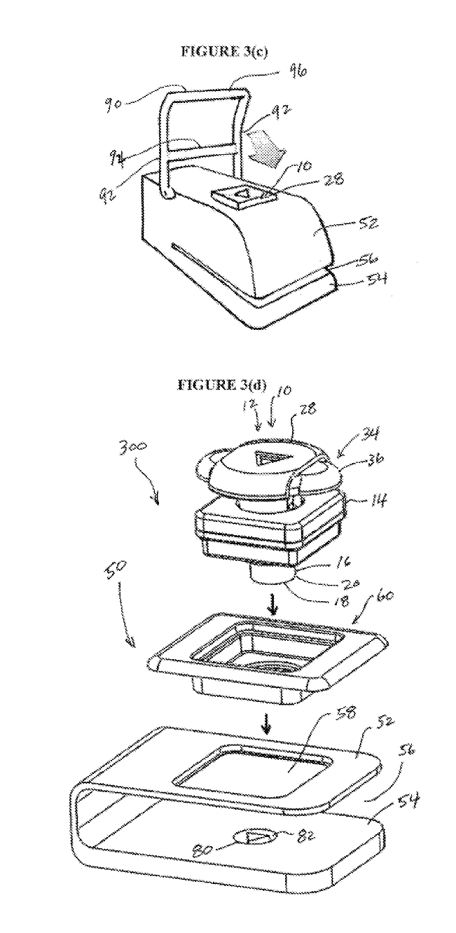

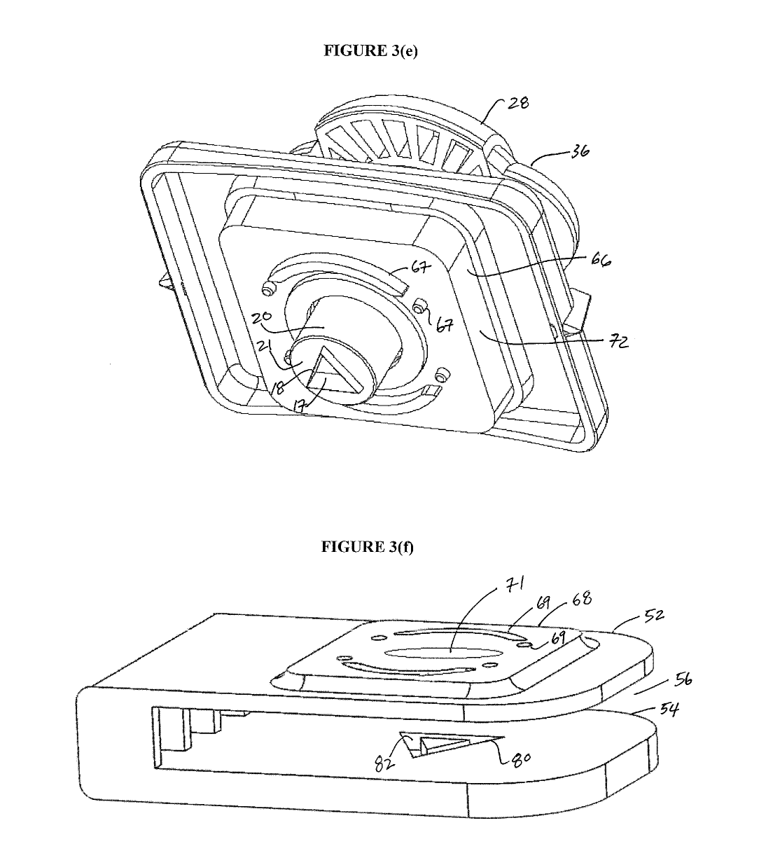

FIGS. 3(a)-3(g) show a third exemplary embodiment of the hole punch system of the present invention. Punch assembly 10 of this third hole punch system 300 may be the same as the punch assembly 10 of second hole punch system 200 or first hole punch system 100 and is removably mounted to a modified frame member 50. In this embodiment, frame member 50 has a substantially compact configuration that fixedly orients punch assembly 10 relative to frame member 50. This compact structure of frame member 50 allows for convenient storage and ease in portability of third hole punch system 300.

In the embodiment shown in FIGS. 3(a)-3(b), frame member 50 has substantially the same configuration as frame member 50 of first and second hole punch systems 100, 200. In this embodiment, however, frame member 50 has a shortened main body and second slot 58. Additionally, mounting device 60 does not permit movable adjustment and positioning of punch assembly 10 relative to frame member 50.

As best shown in FIGS. 3(a)-3(b), punch assembly receiving member 52 and base member 54 are connected at one end and spaced apart from one another so as to form a C-shaped configuration and define a first slot 56 adapted for receiving a material to be hole punched. Preferably, punch assembly receiving member 52 and base member 54 each have a length of about 1.25 inches to about 2 inches, more preferably 1.25 inches to about 1.5 or about 1.5 inches to about 2 inches. Additionally, first slot 56 preferably has a length of about 1.25 inches to about 2 inches, more preferably 1.25 inches to about 1.5 or about 1.5 inches to about 2 inches. As shown, base member 54 has a cutting surface 80 defined by a recessed section 82. Preferably, an upward protruding die may be centrally positioned within the recessed section 82 to facilitate support of the material to be punched as well as facilitate hole punching. The die may have a shape that conforms to the cutting edge 18 of a specific punch assembly 10 or may generally corresponds to multiple different cutting edges 18 of various punch assemblies 10.

In this embodiment, mounting device 60 is integrally formed with and fixedly attached to punch assembly receiving member 52, such that mounting device 60 engages the internal edges of punch assembly receiving member 52 defining second slot 58. Punch assembly 10 may be removably attached to mounting device 60 in the same manner as that described above with respect to first and second hole punch systems 100, 200.

Optionally, the frame member 50 may further include a lever 90 proximate to a distal end of frame member 50 to facilitate activation of punch assembly 10. As shown in FIG. 3(c), lever 90 includes two arms hingedly connected to opposite sides of frame member 50, specifically opposing sides of punch assembly receiving member 52 and is oriented so as not to impede the insertion of a material to be punched within first slot 56. Lever 90 has a wire body having a C-shaped configuration and preferably includes a transverse member 94 centrally located relative to and connecting opposing arms 92. During operation, holding hand grip 96, a user rotates lever 90 in a direction towards the end of frame member 50. When lowered, as illustrated in FIG. 3(c), transverse member 94 contacts and depresses first actuator 28 to initiate hole punching. Lever 90 may be coupled attached to any embodiments of frame members 50 described herein.

In an alternative embodiment shown in FIG. 3(d), hole punch system 300 further includes a mounting device 60 that is removably attached to punch assembly receiving member 52. In this embodiment, mounting device 60 is removably positioned within second slot 58 of punch assembly receiving member 52. Preferably, mounting device 60 is friction fitted within second slot 58 to securely couple punch assembly 10 to frame member 50.

In another alternative embodiment shown in FIGS. 3(e)-3(f), hole punch system 300 has a mounting device 60 that is removably attached to punch assembly receiving member 52. In this embodiment, punch assembly receptacle 66 of mounting device 60 is detachably connected to support frame coupler 68, which is integrally formed with punch assembly receiving member 52. As shown in FIGS. 3(e)-3(f), a lower surface of punch assembly receptacle 66 includes a plurality of connector 67, such as nubs, ribs and other protrusions, that correspond to notches 69 formed in an upper surface of support frame coupler 68 which are adapted to receive and securely fasten to connectors 67.

The hole punch system of the present invention may include one or more punch assemblies 10 and one or more frame members 50 described in any of the aforementioned embodiments of the hole punch system. One or more punch assemblies 10 may therefore be selectively and removably coupled to one or more frame members 50 as desired. In one embodiment, the hole punch system of the present invention includes two or more punch assemblies 10, namely the punch assembly of FIGS. 1(b)-1(c) and FIGS. 2(f)-2(k), and two or more, three or more, or four or more frame members 50, namely the frame members selected from FIGS. 1(e)-1(g); 2(a)-2(l); 3(a)-3(b), 3(d) and 3(e)-3(f). Each punch assembly 10 may have a different cutting edge 18 adapted to form holes and chads of different shapes. These punch assemblies 10 and frame members 50 may be interchangeably coupled to form a modular hole punch apparatus and system for facilitating hole punching.

The hole punch system of the present invention provides a number of advantages over hole punch devices of the prior art. In addition to creating a modular system enabling a user to form hole and chads of different shapes and select an appropriate frame members 50 best suited for a particular application, the hole punch system also enables adjustable, far reaching and precise hole punch placement. Furthermore, the hole punch system provides multiple viewing angles for a user to verify the accurate placement of a material to be punched within the hole punch system and to verify the desired location of a hole punch.

The hole punch system of the present application may be used for a wide variety of applications. It is envisioned, however, that it may be particularly useful as a hand held tool for punching holes in various materials, such as paper, cardboard, foam board, thin plastic sheets, thin metal sheets and fabrics. The chads produced by the hole punch system may have different sizes and shapes that can be used for crafts, such as scrap booking. The greater the variety of the chads in terms of the shape, size and material of the chad, the greater the potential arts and craft use. The hole puncher system of the present invention may also be particularly well suited for use as a standard paper hole punch for purposes of organizing and binding together multiple papers.

The present invention is also directed to a method of using the hole punch system to punch holes in a material. During operation, a user first selects a punch assembly 10 having a desired cutting edge 18 for creating a hole and/or chad having a desired shape and selects a frame member 50 having a desired configuration suitable for enabling a specific application. The selected punch assembly 10 is then removably attached to a mounting device 60 of the selected frame member 50 such that casing lower section 32 is positioned within recessed seat 72 and such that ram first end 20 extends down through punch assembly receptacle and support frame coupler holes 70, 71. For example, punch assembly 10 may be screwed into or snap fitted into mounting device 60. When frame member 50 has a slide track 62, as described in first and second hole punch system 100, 200, punch assembly 10 and mounting device 60 may be movably positioned along the length of slide track 62. This slidable adjustment of punch assembly 10 enables precise and far reaching hole punch placement. Furthermore, a user may measure and precisely locate a desired hole punch location by slidably aligning mounting device 60 and punch assembly 10 relative to one or more scales 65 formed on opposite sides of slide track 62 proximate to ledge 64.

Upon inserting a material to be punched in first slot 56, a user can then directly view the location of punch assembly 10, specifically ram first end 20 and cutting edge 18, relative to the material located within first slot 56 to confirm the accurate placement of punch mechanism 12. Specifically, the user may view and verify the location of ram first end 20 and cutting edge 18 relative to the material to be punched by looking through second slot 58 formed by slide track 62. Additionally, the user may look through a side of first slot 56 defined by the C-shaped main body of frame member 50 to verify accurate placement of ram first end 20 and cutting edge 18. When using the punch assembly 10 shown in FIG. 1(b), it may be further possible to view the material to be punched through a hole formed in the upper surface of first actuator 28 that extends through the length of ram 16.

Upon identifying and verifying the location of the intended hole punch, a user may then apply pressure to an upper surface of first actuator 28 to vertically depress ram 16 through first slot 56 down towards cutting surface 80 of base member 54, as shown in FIGS. 1(c) and 2(j). First spring 26 which surrounds a portion of ram 16 and abuts an interior surface of casing lower section 32 and a ram ledge 24 or first actuator rim 29, resists the depression of first actuator 28 such that upon releasing the pressure applied to first actuator 28, punch mechanism 12 automatically reassumes its original position wherein first actuator 28 protrudes upwards through casing upper section opening 31 and ram first end 20 does not extend down past hole 71 formed by support frame coupler 68. This process may be repeated as desired to punch a hole at one or more locations through a material by slidably adjusting the position of frame assembly 10 and mounting device 60 and subsequently activating first actuator 28 to induce hole punching.

Punch assembly 10 may then be removed from mounting device 60 and replaced with another punch assembly 10 having a cutting edge 18 of a different configuration. Preferably, punch assembly 10 may be removed by simply pulling upward on first actuator 28 and/or casing upper section 30 with a sufficient amount of force to overcome the friction fitted or screw fitted attachment of casing lower section 32 within recessed seat 72 of mounting device 60.

When using punch assembly 10 and support frame 50 of first hole punch system 100 shown in FIGS. 1(a)-1(g), chads formed by hole punching fall within down into and are accumulated within recessed section 82 of base member 54. Upon turning support frame 50 on its side and shaking the hole punch system, it is possible to dislodge the chads so that they are removed from frame member 50 by passing through first slot 56.

When using the punch assembly 10 and support frame 50 of second hole punch system 200 shown in FIGS. 2(a)-2(l), chads formed by hole punch are pushed by resilient mat 84 upwards through the hole 17 defined by cutting edge 18 and stored within chad receptacle 15 within ram 16. Punch assembly 10 is then removed from mounting device 60, and second actuator 36 is depressed independently from first actuator 28 to initiate chad discharge, as shown in FIG. 2(k). The chads are pushed out and through hole 17 as plunger 38 is vertically lowered through chad receptacle 15 until an end of plunger 38 is positioned within or extends through hole 17. Once the chads are ejected, punch assembly 10 may be reattached to mounting device 60. Alternatively, another punch assembly 10 may be removably coupled to mounting device 60.

The resilient mat 84 attached to an upper surface of recessed section 82 may be detached from base member 54 and replaced as necessary. A user simply presses against clip 86 which slides apart from base member 54 revealing an access opening through which mat 84 may be removed from recessed section 82. A replacement mat 84 may be subsequently friction fitted or adhesive attached to recessed section 82. Clip 86 may then be slid back into place.

Punch assembly 10 may also be coupled to the frame member 50 of third hole punch system 300. Due to its compact size, this frame member 50 may be particularly suitable for use during travel. In the embodiment shown in FIGS. 3(a)-3(b), punch assembly 10 is removably snap fastened to a mounting device 60 fixedly attached to frame member 50 such that casing lower section 32 is positioned within recessed seat 72 and such that ram first end 20 is capable of extending down through the support frame coupler hole 71. When using the embodiment shown in FIG. 3(d), mounting device 60 is removably attached to punch assembly receiving member 52 so as to be securely seated within second slot 58, and punch assembly 10 is removably attached to mounting device 60. In the embodiment of FIGS. 3(e)-3(f), punch assembly receptacle 66 is detachably mounted to support frame coupler 68 by inserting connectors 67 into notches 69, and punch assembly 10, removably seated within mounting device 60, is thereby removably coupled to punch assembly receiving member 52.

By virtue of this removable, interchangeable design of the hole punch system of the present invention, a user is therefore able to selectively couple one or more punch assemblies 10 having a specific hole and chad size, shape and configuration to one or more support frames 50 as desired to enable various hole punching applications.

Several embodiments of the present invention have been described herein. Nevertheless, it will be understood that various modifications may be made without departing form the spirit and scope of the invention. Accordingly, other embodiments are within the scope of the following claims.

What is claimed is:

1. A hole punch system comprising:
a punch assembly for punching a hole in a material, wherein the punch assembly comprises:
a punching means for punching a hole in a material; and
a chad discharge means for storing and discharging chads, wherein the punching means and chad discharge means are interrelated but operatively independent of one another.

2. The system of claim 1, wherein the punching means comprises:
a ram comprising a cutting edge for punching the hole in the material; and
a first actuator that adjoins and induces the ram to punch a hole in the material.

3. The system of claim 2, wherein the chad discharge means comprises:
a plunger operatively associated with the ram,
wherein the ram further comprises a receptacle for storing the chads and wherein the plunger is positioned within a portion of the receptacle and is capable of dispensing chads accumulated within the receptacle through a hole defined by the cutting edge.

4. The system of claim 2, wherein the cutting edge has a tapered configuration.

5. The system of claim 3, wherein the chad discharge means further comprises a second actuator attached to and capable of lowering the plunger through the receptacle to discharge the accumulated chads, wherein the second actuator is positioned within the first actuator.

6. The system of claim 3, wherein the system further comprises a frame member, wherein the frame member comprises:
a main body through which is formed a first slot for receiving the material to be punched; and
a mounting device having a cavity for receiving and coupling the punch assembly to the frame member.

7. The system of claim 6, further comprising two or more of the punch assemblies, wherein the ram of at least two of the punch assemblies have a different shaped cutting edge forming different shaped holes, and wherein each punching assembly is removably and interchangeably attached to the mounting frame.

8. The system of claim 6, wherein the main body further comprises a slide track forming an elongated second slot positioned through a portion of the main body, wherein the punch assembly is removably and slidably attached to the slide track and capable of passing through the second slot at various locations along a length of the second slot to enable adjustable hole punch placement in the material.

9. The system of claim 8, wherein the main body further comprises a cutting surface comprising a resilient mat that provides back pressure against the ram during hole punching.

10. The system of claim 9, wherein the resilient mat is removably attached to the cutting surface and wherein the main body comprises a removable clip that permits access to and facilitates replacement of the resilient mat.

11. The system of claim 6, wherein the main body further comprises:
a base member; and
a punch assembly receiving member that is connected to and spaced apart from the base member, wherein the base member and punch assembly receiving member define the first slot, wherein the punch assembly mounting member comprises a second slot for removably receiving the mounting frame and wherein the second slot is positioned through the punch assembly mounting member that is positioned above and connected to the first slot.

12. The system of claim 6, wherein the system further comprises two frame members having different configurations which may be removably and interchangeably coupled to the punch assembly.

13. A hole punch system comprising:
an elongated frame member for receiving and punching a hole in a material, wherein the frame member comprises:
a base member; and
a punch assembly receiving member connected to and spaced apart from the base member to form a first slot for receiving the material, wherein the punch assembly receiving member comprises a slide track forming an elongated second slot positioned through the punch assembly receiving member, wherein the second slot has a horizontal longitudinal axis and is positioned above and is connected to the first slot; and
a punch assembly slidably attached to the slide track and capable of passing through the second slot at various locations along a length of the second slot to enable adjustable hole punch placement in the material, wherein a user is able to view the material through the second slot to facilitate hole punch placement.

14. The system of claim 13, wherein the frame member further comprises a mounting device slidably coupled to the punch assembly receiving member and capable of being removably attached to the punch assembly, and
wherein the system further comprises two or more punch assemblies, wherein each punch assembly comprises a ram having a distal cutting edge for forming a hole in the material, and wherein the ram of at least two punch assemblies have different shaped cutting edges forming different shaped holes.

15. The system of claim 14, wherein the punch assembly comprises a chad discharge means for storing and discharging chads.

16. The system of claim 15, wherein the punch assembly further comprises a lever attached to the punch assembly receiving member that is operatively associated with the punch assembly to facilitate activation of the hole punch assembly.

17. A method for hole punching comprising the steps of:
positioning a material within a first slot of a hole punch apparatus;
looking through an elongated second slot positioned through a punch assembly receiving member of the hole punch apparatus to view the material positioned within the first slot and a desired hole punch location of the material;
slidably positioning a first punch assembly along a track of the punch assembly receiving member forming the second slot so as to align the first punch assembly with the desired hole punch location; and
actuating the first punch assembly to punch a hole in the material.

18. The method of claim 17 further comprising the step of removing the first punch assembly from the hole punch apparatus and interchanging it with a second punch assembly that produces a different shaped hole.

19. The method of claim 17 further comprising the step of removing the first punch assembly from a first frame member of the hole punch apparatus and coupling the first punch assembly to a second frame member of the hole punch apparatus.

20. The method of claim 17 further comprising the step of removing the first punch assembly from the hole punch apparatus and activating a mechanism of the first punch assembly to discharge chads stored within a receptacle of the first punch assembly.
